(19) United States
(12) Patent Application Publication
(10) Pub. No.: US 2013/0182229 A1
(43) Pub. Date: Jul. 18, 2013

(54) PROJECTION TYPE IMAGE DISPLAY APPARATUS

(71) Applicant: Panasonic Corporation, Osaka (JP)

(72) Inventors: Naoto SARUWATARI, Osaka (JP); Mamoru NOMOTO, Osaka (JP); Hirokazu SAKAGUCHI, Osaka (JP); Masakazu OKUDA, Osaka (JP)

(73) Assignee: PANASONIC CORPORATION, Osaka (JP)

(21) Appl. No.: 13/740,768

(22) Filed: Jan. 14, 2013

(30) Foreign Application Priority Data
Jan. 17, 2012 (JP) 2012-007299

(51) Int. Cl. G03B 21/20

(52) U.S. Cl. CPC G03B 21/2013
USPC 353/30

(57) ABSTRACT

An opening cover of a case is removed. A light source module is held, and the light source module is pulled outside an opening of the case while guide groove parts and guide-rail parts slide along each other approximately parallelly to a case base. At this moment, junction cable connection terminals of the light source module become separated from power-supply connection terminals of a composite optical system. Replacement of a light source is conducted by replacing the light source module as a unit, or by replacing a light source section or a light source section each as a unit.

### BACKGROUND OF THE INVENTION

1. Field of the Invention

The present disclosure relates to a projection type image display apparatus including multiple light sources, and, more specifically, relates to a structure for removing a light source from a projection type image display apparatus to replace the light source.

2. Description of the Background Art

Generally, in a projection type image display apparatus referred to as a projector, a discharge lamp such as a high pressure mercury vapor lamp is used as a light source. With this discharge lamp, high brightness can be obtained with a small luminous body; however, since a plasma state is generated therein through inter-electrode electric discharges, the discharge lamp becomes close to as hot as 1000° C. and pressure therein becomes close to as high as 200 atm. Therefore, a lifespan of the discharge lamp representing the number of hours before its brightness is reduced to half is as short as 1500 to 3000 hours.

Since the lifespan of a discharge lamp used as a light source is short, a projection type image display apparatus has a light source removal structure that allows a user of the apparatus to easily replace the light source by himself/herself without the help of a highly skilled serviceman. For example, Japanese Laid-Open Patent Publication No. 11-231413 (Patent Literature 1) and Japanese Laid-Open Patent Publication No. 2008-176199 (Patent Literature 2) disclose projectors having structures for removing light sources.

With the structure of the projector disclosed in Patent Literature 1, when removing a light source from the projector for replacement, a lamp case unit having incorporated therein the light source is slid in the front-rear direction with respect to a case (cf. FIG. 3 etc., of Patent Literature 1).

With the structure of the projector disclosed in Patent Literature 2, when removing a light source from the projector for replacement, a light source device having incorporated therein the light source is slid in the up-down direction with respect to a case (cf. FIG. 3 etc., in Patent Literature 2).

In recent years, as a technology for improving brightness of a picture projected onto a screen by a projection type image display apparatus, a technology of increasing the amount of light through the usage of multiple light sources has been proposed. One example is a projection type image display apparatus disclosed in Japanese Laid-Open Patent Publication No. 2010-33988 (Patent Literature 3). In the projection type image display apparatus disclosed in Patent Literature 3, four light sources are used, and projection of pictures having super-high brightness is achieved by optimally combining light emitted from the four light sources with a small loss.

However, in a projection type image display apparatus including multiple light sources as proposed by Patent Literature 3, the multiple light sources are generally arranged in a planar manner. Therefore, when the technology disclosed in Patent Literature 1 is simply applied to a projection type image display apparatus including multiple light sources, even if it is possible to remove an outer mostly arranged light source from a lateral surface of the case, other light sources arranged behind the removable light source cannot be easily removed.

Furthermore, when the technology disclosed in Patent Literature 2 is simply applied to a projection type image display apparatus including multiple light sources, it is possible to obtain a structure allowing removal of each light source from the top surface of the case no matter where in the case the light sources are arranged. However, in some instances, a plurality of such projection type image display apparatuses are stacked on top of one another to be used. In such a usage mode, some of the projection type image display apparatuses will have cases whose top surfaces are blocked, leading to a problem of not being able to easily replace a light source.

### SUMMARY OF THE INVENTION

The present disclosure provides a projection type image display apparatus that allows, even when the projection type image display apparatus includes multiple light sources, a user of the apparatus to easily and efficiently remove and replace all of the multiple light sources.

The present disclosure is directed toward a projection type image display apparatus including, in a case thereof, multiple light source sections for outputting light. In order to achieve the above described object, the projection type image display apparatus of the present disclosure includes: a light source module including, as a unit, at least two light source sections among the multiple light source sections; a composite optical system configured to combine light outputted from each of the at least two light source sections included in the light source module; an illumination optical system configured to parallelly output the light combined by the composite optical system; and a projection optical system configured to modulate and project, onto a screen, the parallel light outputted by the illumination optical system, wherein the case includes guide parts configured to move in and out the light source module through an opening disposed on a lateral surface of the case.

With the projection type image display apparatus of the present disclosure, even when the apparatus includes multiple light sources, a user can easily remove and replace one portion or all of the multiple light sources.

These and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1A, FIG. 1B, FIG. 2A, and FIG. 2B, are external perspective diagrams showing external structures of a projection type image display apparatus 100 according to one embodiment;

FIG. 3A and FIG. 3B are perspective diagrams schematically showing main internal components in a state where an exterior case of the projection type image display apparatus 100 according to the present embodiment shown in FIG. 1A is removed;

FIG. 4A and FIG. 4B are perspective diagrams schematically showing the structure of a light source module 110;

FIG. 5 is a perspective diagram schematically showing the structures of light source sections 111 and 112;

FIG. 6 is a perspective diagram schematically showing the structure of the light source module 110;

FIG. 7 is a perspective diagram schematically showing the structure of a composite optical system 130;

FIG. 8A and FIG. 8B are perspective diagrams for describing how the light source module 110 is removed from the composite optical system 130; and

FIG. 9A and FIG. 9B are perspective diagrams for describing how the light source module 110 is attached to the composite optical system 130.

### DESCRIPTION OF THE PREFERRED EMBODIMENTS

Hereinafter, embodiments will be described in detail with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The inventors provide the following description and the accompanying drawings in order to allow a person of ordinary skill in the art to sufficiently understand the present disclosure, and the description and the drawings are not intended to restrict the subject matter of the scope of the patent claims.

The present disclosure is a technology applicable to a projection type image display apparatus including multiple light sources.

In the following embodiment, characteristic structures will be described using, as one example, a projection type image display apparatus including four light sources.

<External Structure>

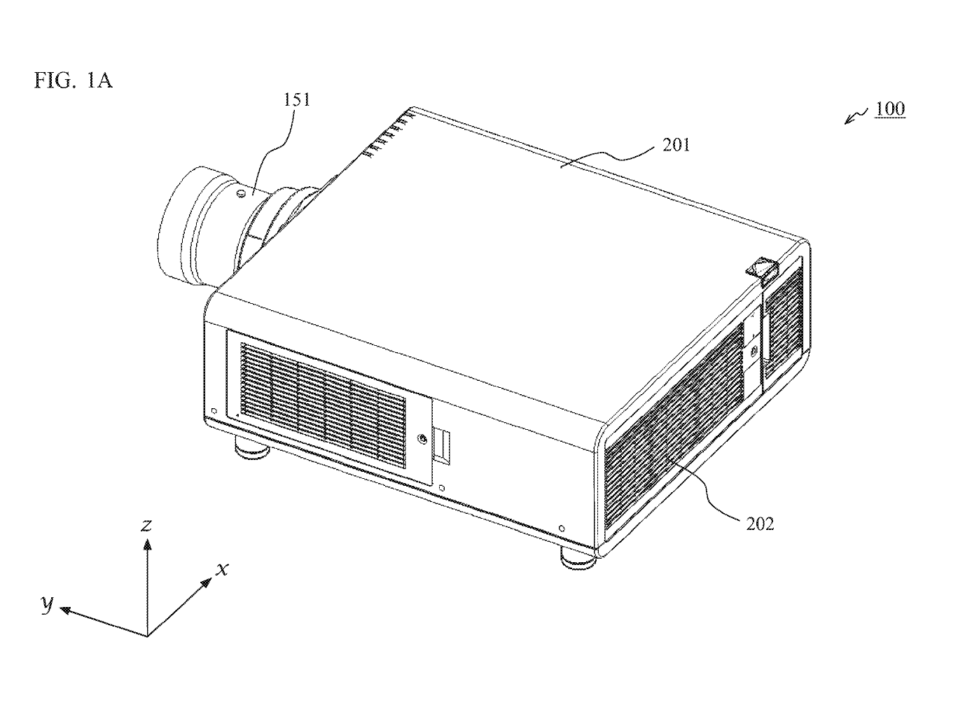

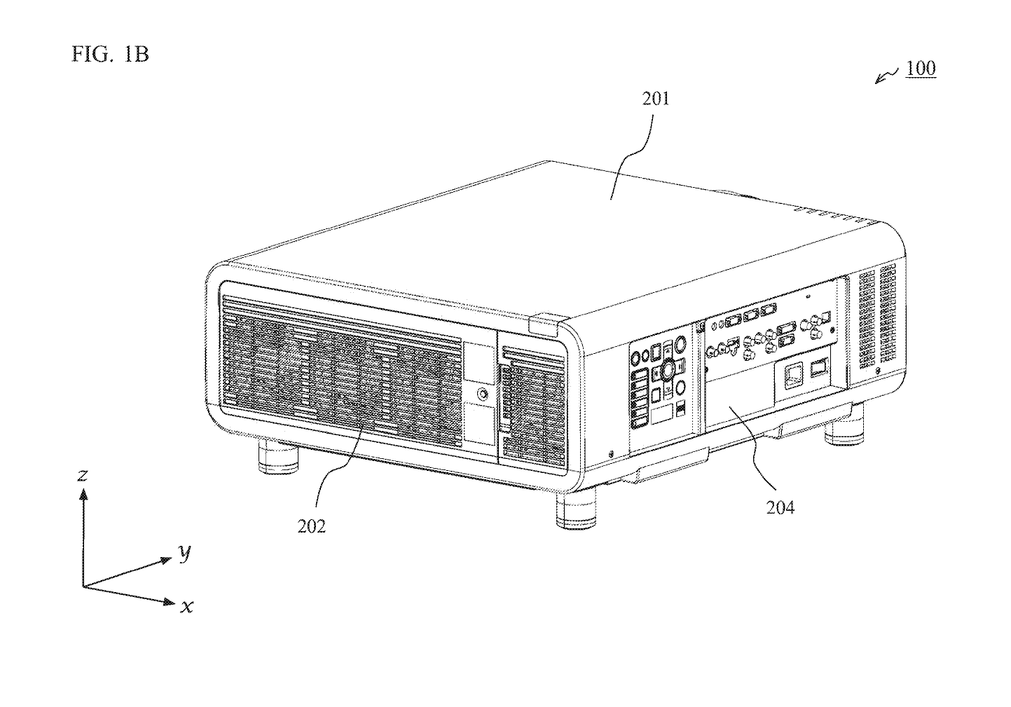

FIG. 1A and FIG. 1B are external perspective diagrams showing the external structure of a projection type image display apparatus 100 according to one embodiment. FIG. 1A is a perspective diagram viewing the projection type image display apparatus 100 from its back upper left portion with respect to its front which is a direction to which images are projected. FIG. 1B is a perspective diagram viewing the projection type image display apparatus 100 from its back upper right portion with respect to its front. The projection type image display apparatus 100 according to the present embodiment has a case 201 having an approximately parallelepiped shape with four lateral surfaces, and a top surface and a bottom surface having the largest area size among the surfaces. The projection type image display apparatus 100 has a structure in which a part of a projection lens 151 protrudes out from the case 201. The projection type image display apparatus 100 has a function of receiving image data via an input/output interface section 204 as an external input, and projecting an enlarged image toward a screen (not shown) through the projection lens 151.

An opening 205 with a cover 202 is provided on a lateral surface (rear surface) of the case 201 opposite from a lateral surface (front surface) of the case 201 from which the projection lens 151 protrudes. As shown in FIG. 2A and FIG. 2B, the opening cover 202 is formed so as to be detachable from the case 201 with a usage of an attachment member such as a screw. By removing the opening cover 202 from the case 201, the opening 205 is exposed and replacement of a light source module 110 and a light source module 120 included in the case 201 can be conducted easily.

<Internal Structure>

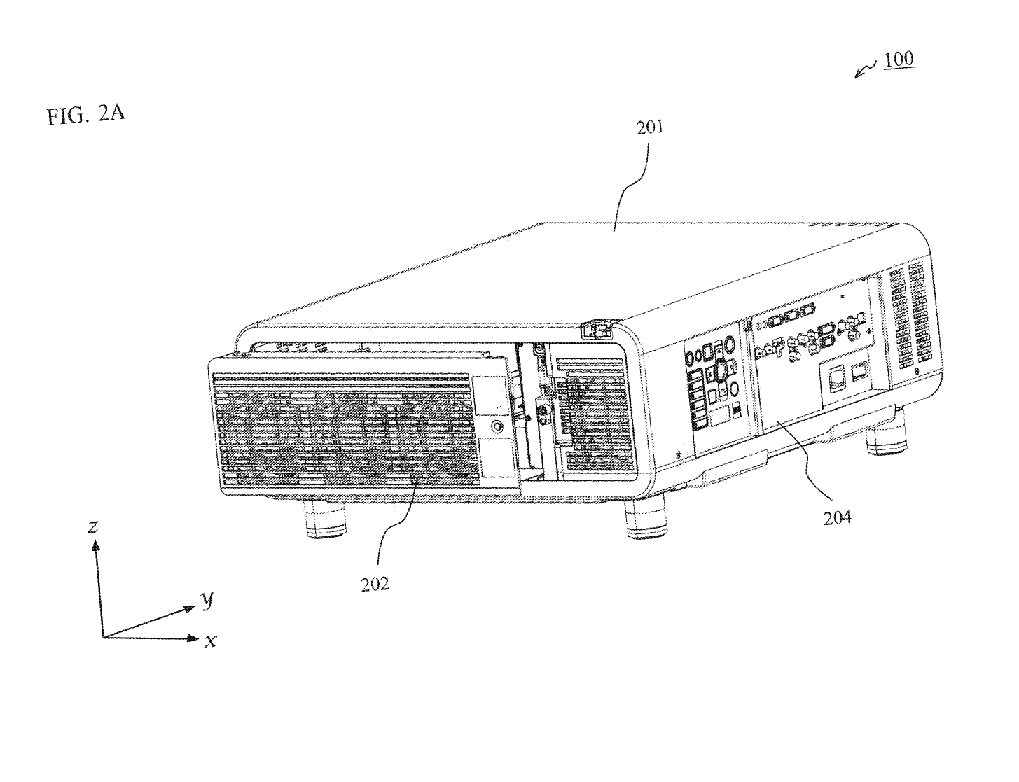

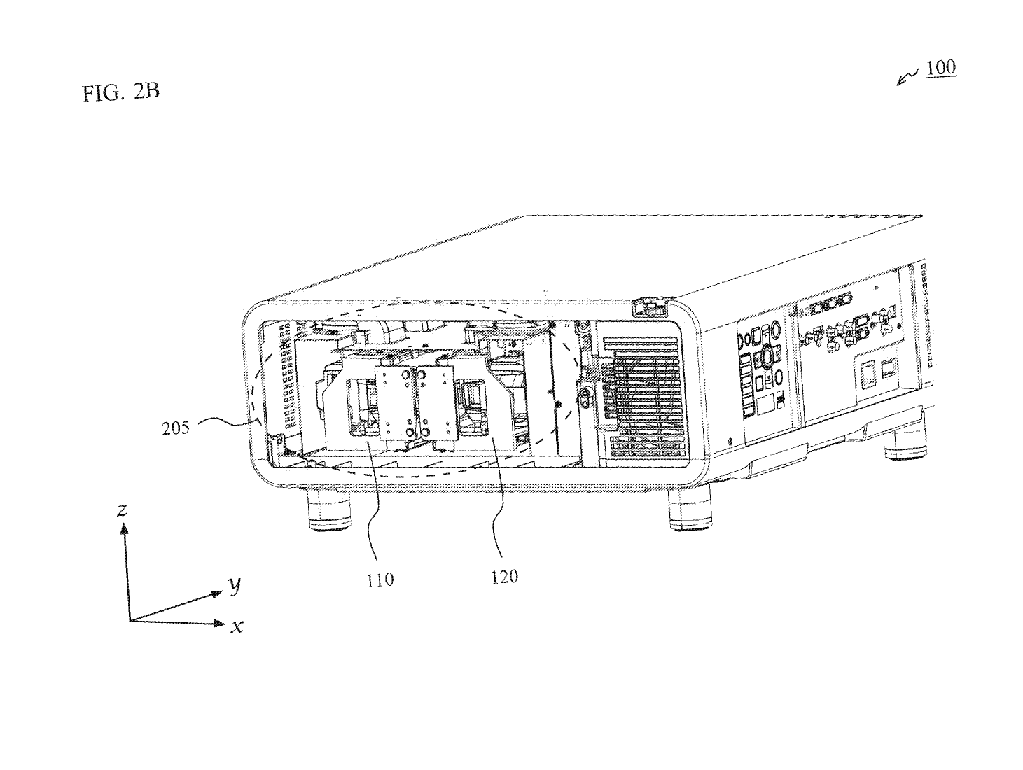

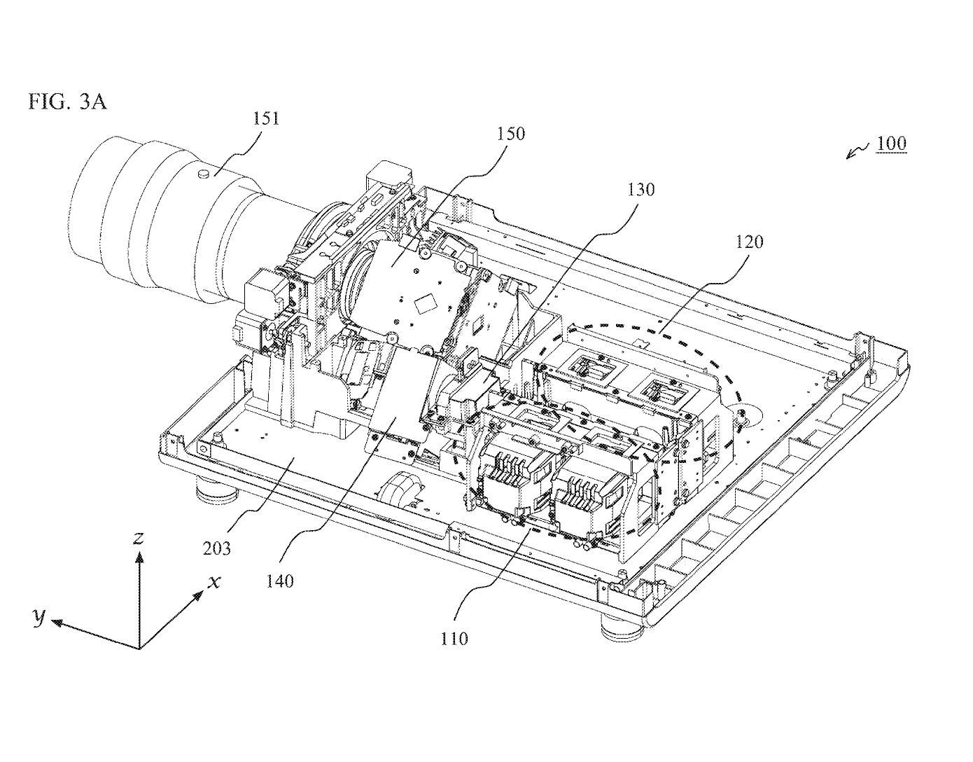

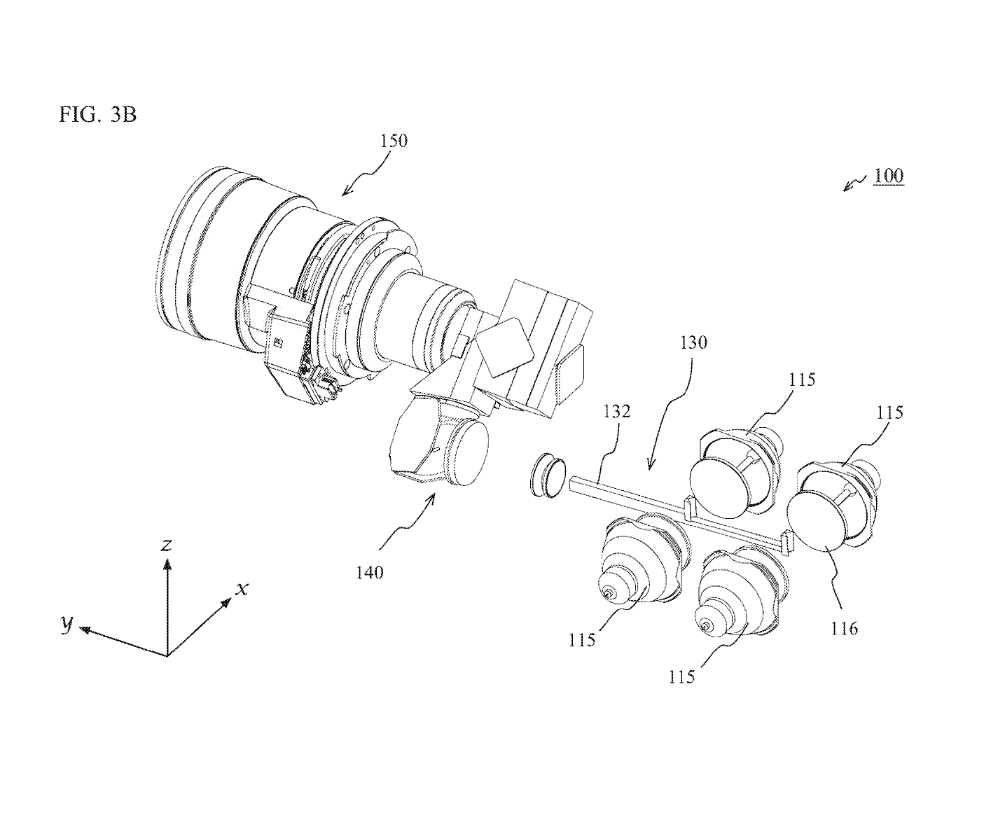

FIG. 3A is a perspective diagram showing main internal components installed on a case base 203 in a state where the exterior case of the projection type image display apparatus 100 according to the present embodiment shown in FIG. 1A is removed. FIG. 3B is a schematic diagram further simplifying the main components shown in FIG. 3A with regard to an optical system.

In FIG. 3A and FIG. 3B, the projection type image display apparatus 100 according to the present embodiment includes the two light source modules 110 and 120, a composite optical system 130, an illumination optical system 140, and a projection optical system 150.

It should be noted that the projection type image display apparatus 100 generally includes, in addition to the above described components, components such as a light source driving circuit, a picture processing circuit, a cooling fan, an intake port, and an exhaust port; however, these components are not a principal objective of the present disclosure and thereby are omitted in FIG. 3A and FIG. 3B.

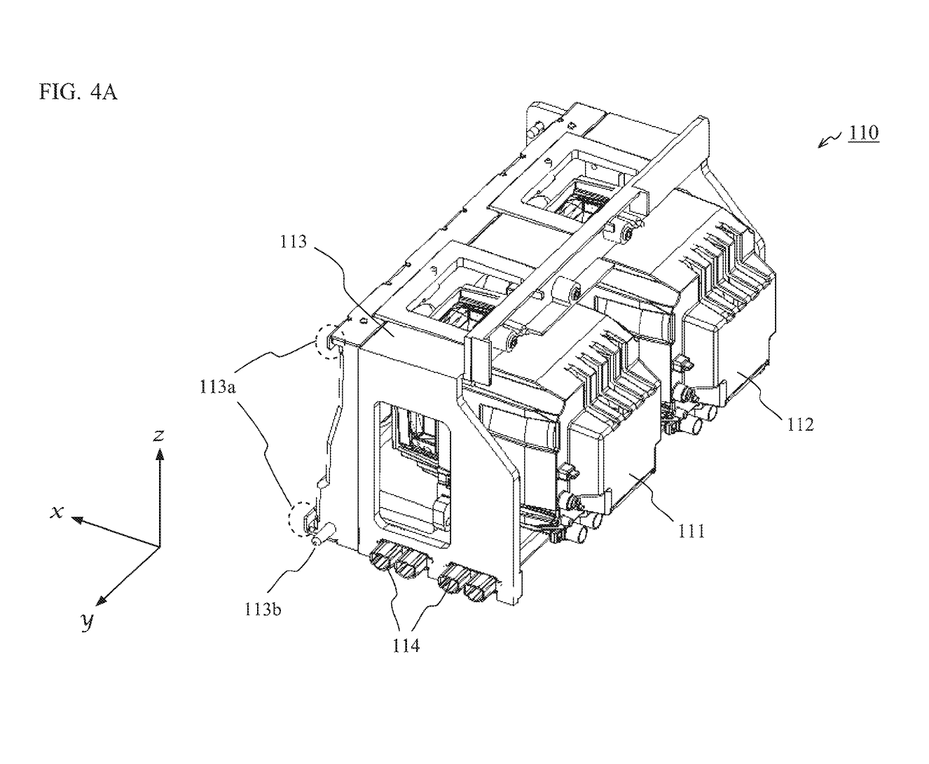

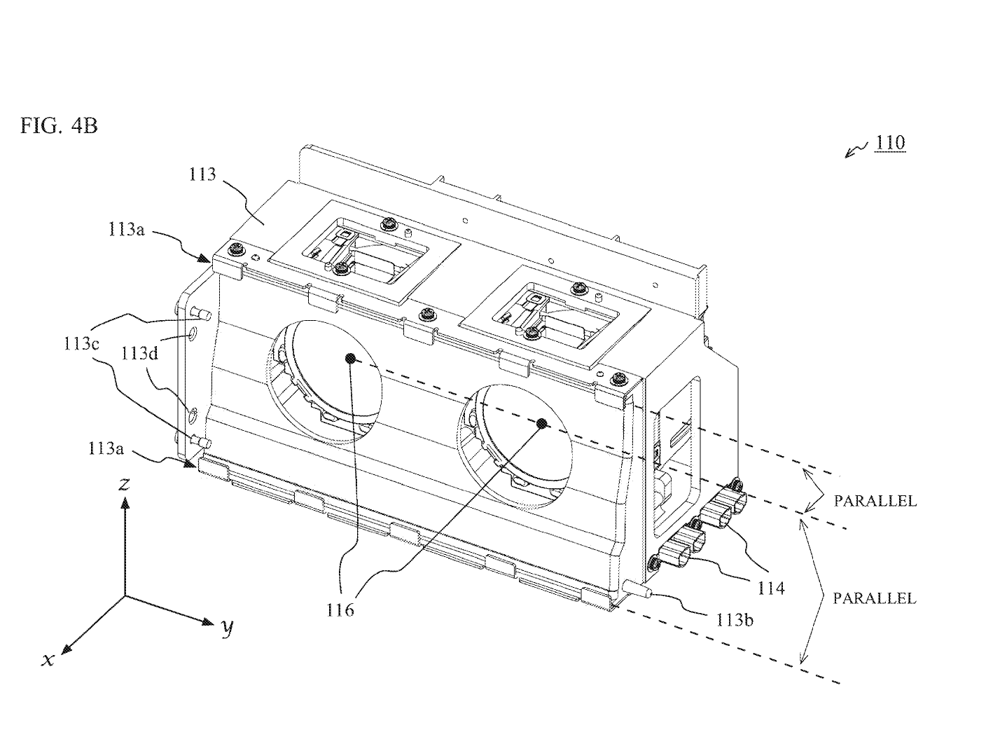

As schematically shown in FIG. 4A and FIG. 4B, the light source module 110 has a structure in which two light source sections 111 and 112 are housed in a unit case 113. The unit case 113 has strength that can sufficiently support the weight of the light source section 111 and the light source section 112 housed in unit case 113, and is formed from a heat resistance resin, a metal such as aluminum, or the like to withstand heat from the light source sections. The unit case 113 has formed thereon guide groove parts 113a that form guide parts in combination with guide-rail parts 131a included in a later-described composite base 131 of the composite optical system 130. The guide groove parts 113a are disposed at top and bottom edges of a lateral surface of the unit case 113, facing the composite optical system 130 and being located on a light emitting direction side of the light source section 111 and the light source section 112. It should be noted that the guide groove parts 113a may be formed as components separate from the unit case 113 (as in the example shown in FIG. 4A and FIG. 4B), or may be integrally formed with the unit case 113 as a single component.

In order to assist secure installation of the light source module 110 to the composite optical system 130, the unit case 113 has formed thereon a first protrusion 113b, a second protrusion 113c, and a hole part 113d at positions corresponding respectively to a first hole part 131b, a second hole part 131c, and a protrusion 131d (described later) disposed on the composite base 131 of the composite optical system 130. In addition, the unit case 113 includes junction cable connection terminals 114 which are terminals for connecting junction cables connected to the light source section 111 and the light source section 112 to supply power. The first protrusion 113b is formed so as to extend further outward from the unit case 113 than the junction cable connection terminals 114. In other words, a protruding portion of the first protrusion 113b is longer than protruding portions of the junction cable connection terminals 114. This difference in the lengths of the protruding portions enables the first protrusion 113b to align positions of the junction cable connection terminals 114 and power-supply connection terminals 134 (described later) provided on the composite optical system 130. The junction cable connection terminals 114 fit the power-supply connection terminals 134 to form electrical connection.

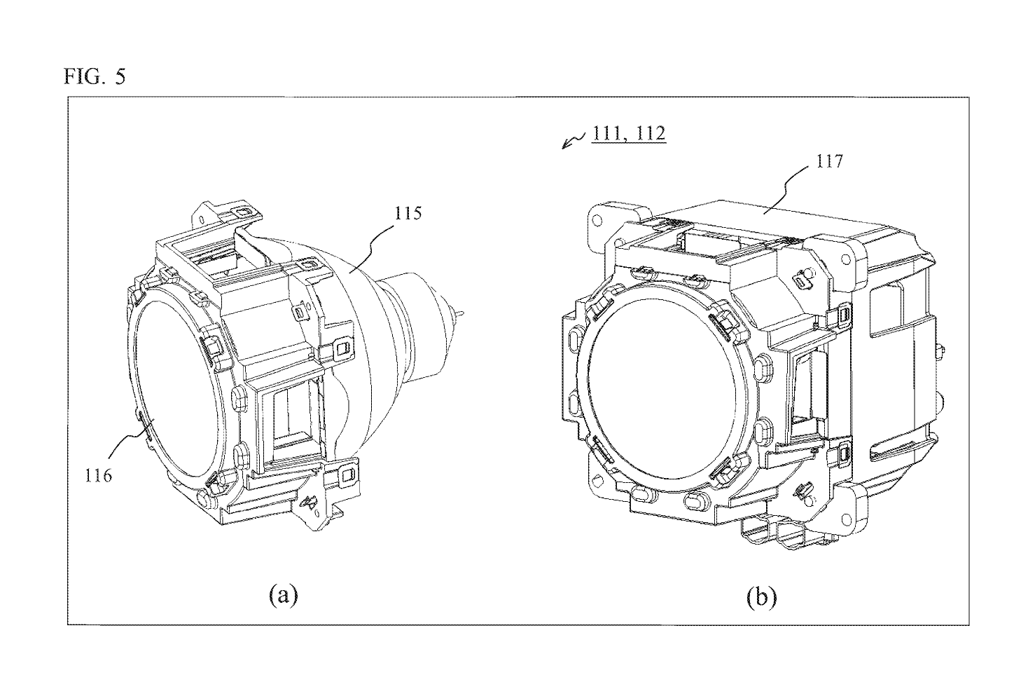

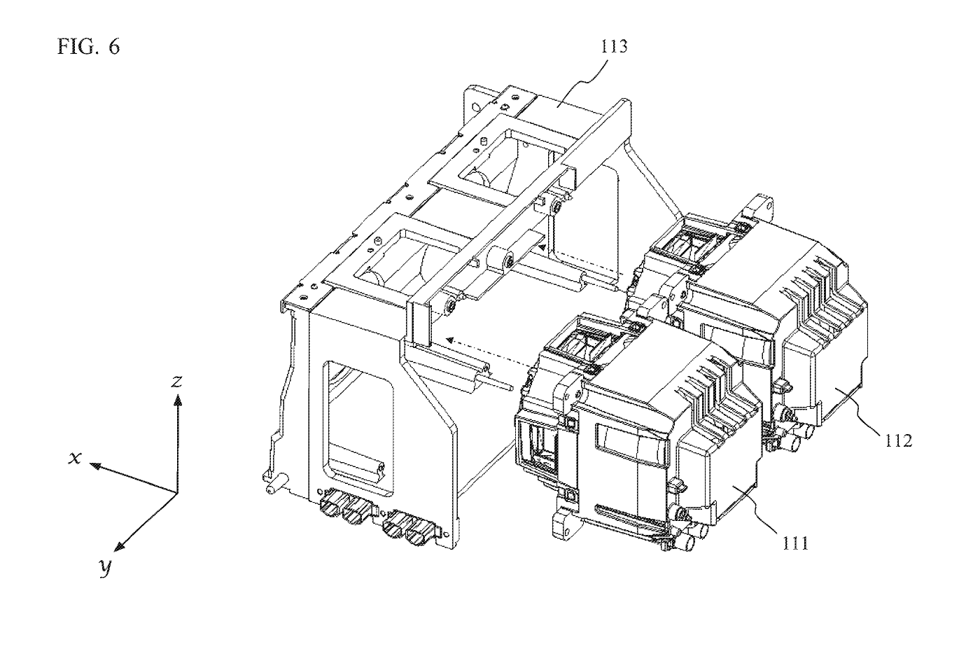

The light source section 111 and the light source section 112 each have a light source 115 for generating light and a light condensing lens 116 for condensing the light generated by the light source 115 ((a) of FIG. 5). For example, a discharge lamp such as a high pressure mercury vapor lamp is used as the light source 115. The light source 115 and the light condensing lens 116 are housed in a designated lamp holder 117 ((b) of FIG. 5), and the lamp holder 117 is housed in the unit case 113 (cf. FIG. 6). Here, preferably, the light source section 111 and the light source section 112 are arranged adjacent to each other; and the lamp holders 117 are housed in the unit case 113 in an arrangement such that an optical axis of the light source section 111 and an optical axis of the light source section 112 are parallel, and that a straight line intersecting the optical axis of the light source section 111 and the optical axis of the light source section 112 is parallel to the guide groove parts 113a (cf. dashed lines in FIG. 4B). It should be noted that, when the light source module 110 has multiple light source sections, the lamp holders 117 are housed in the unit case 113 in an arrangement such that optical axes of all the light source sections are parallel and intersect a straight line.

It should be noted that the light source module 120 has the same components and same configuration as the light source module 110 described above, and its structure is bilaterally symmetric to the light source module 110. Therefore, description of the light source module 120 is omitted.

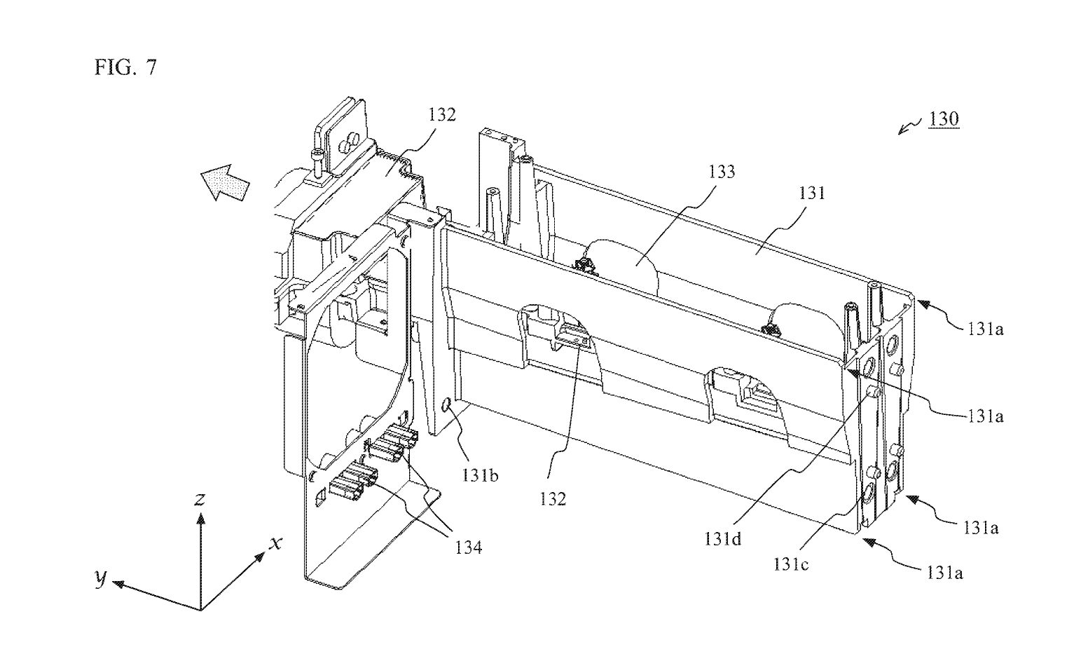

As shown in FIG. 7, the composite optical system 130 includes the composite base 131, an optical composite section 132, windows 133, and the power-supply connection terminals 134. The composite base 131 has formed thereon the guide-rail parts 131a that enable the guide groove parts 113a formed on the light source module 110 and the light source module 120 to slidingly fit thereto. The composite base 131 has strength that can sufficiently support the weight of the light source module 110 and the light source module 120 installed on the composite base 131, and is formed from a heat resistance resin, a metal such as aluminum, or the like to withstand heat from the light source sections. In addition, the guide-rail parts 131a are each formed, for the guide groove parts 113a of the light source module 110, at top and bottom edges of a lateral surface facing the light source module 110, and, for the guide groove parts 113a of the light source module 120, at top and bottom edges of a lateral surface facing the light source module 120.

In order to assist secure insertion of the light source module 110, the composite base 131 has formed thereon the first hole part 131b, the second hole part 131c, and the protrusion 131d at positions corresponding respectively to the first protrusion 113b, the second protrusion 113c, and the hole part 113d disposed on the unit case 113 of the light source module 110. Furthermore, the windows 133 are formed to allow, when the light source module 110 and the light source module 120 are installed on the composite base 131, passage of light generated by each of the light sources 115 included in the modules. The optical composite section 132 is formed from components such as prisms, reflective mirrors, and rod integrators, and combines incidence light passing through the windows 133 into one, and outputs this composite light toward the illumination optical system 140 (arrow direction in FIG. 7). The power-supply connection terminals 134 are terminals to which the junction cable connection terminals 114 of the light source module 110 and the light source module 120 are connected, and power for driving the light source 115 is supplied thereto.

The illumination optical system 140 guides the composite light outputted from the composite optical system 130 to a light bulb unit (not shown) having a transmissive liquid crystal panel, a DMD (digital mirror device) which is an image display element, or the like, such that the light is condensed and emitted.

The projection optical system 150 is formed, for example, from the projection lens 151 etc., and enlarges and projects on to a screen (not shown) to-be-projected picture data generated by the light bulb unit (not shown).

<Light Source Replacement Procedure>

A simple replacement procedure for the light sources 115 provided by the projection type image display apparatus 100 according to one embodiment having the above described configuration will be described. It should be noted that the structures of the light source module 110 and the light source module 120 are bilaterally symmetric but the same replacement procedure is used. Therefore, the replacement procedure of the light source 115 for the light source module 110 will be described in the following.

(1) When removing, from the case 201, a light source 115 or the like that has ceased to emit light.

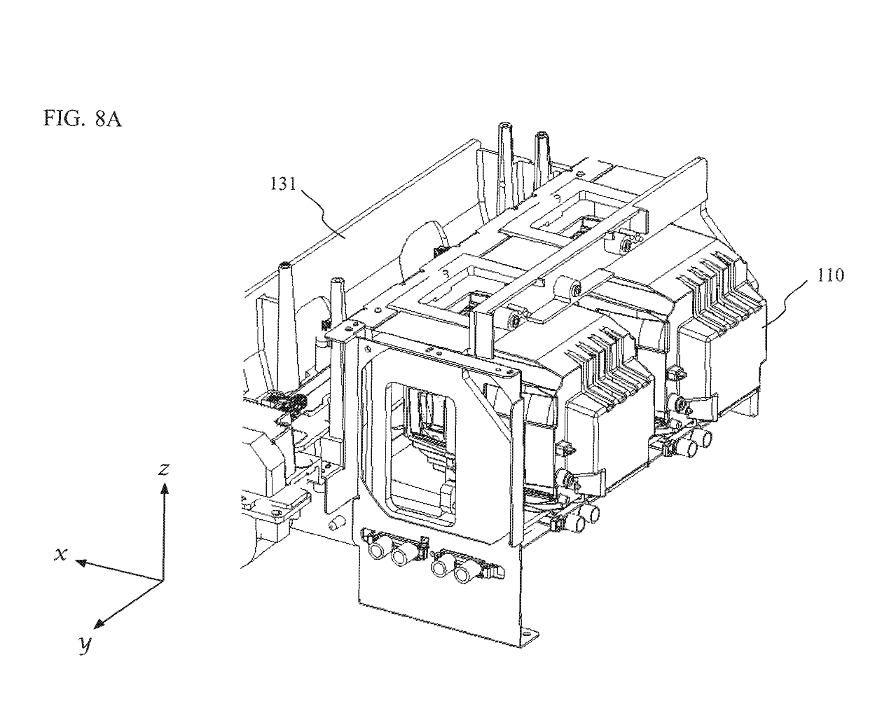

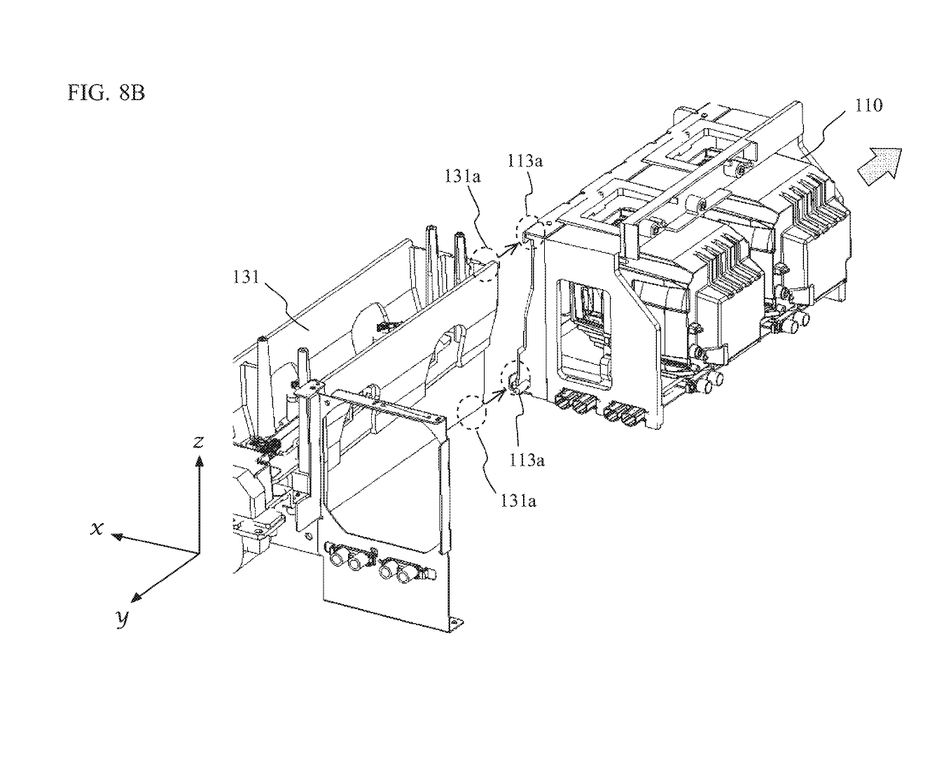

First, the opening cover 202 of the case 201 is removed (FIG. 2B). At this moment, it is preferable to have, between the case 201 and the opening cover 202, a function (e.g., push switch etc.) (not shown) for switching a supply state of a main power supply, such that power supply to each circuit of the projection type image display apparatus 100 is stopped when the opening cover 202 is removed from the case 201. Inside the case 201, as shown in FIG. 8A, the light source module 110 is installed on the composite base 131 of the composite optical system 130.

Next, the light source module 110 is held, and the light source module 110 is pulled outside the opening 205 of the case 201 while the guide groove parts 113a and the guide-rail parts 131a slide along each other approximately parallelly to the case base 203 (FIG. 8B). For this moment, it is possible to have a structure in which the light source module 110 is fully separated from the case 201, or a structure in which the light source module 110 is not fully separated from the case 201 by providing a stopper (not shown) or the like on the unit case 113 or the composite base 131 such that the light source module 110 does not slide beyond a predetermined distance. Furthermore, when the light source module 110 is pulled outside the opening 205 of the case 201, the junction cable connection terminals 114 of the light source module 110 become separated from the power-supply connection terminals 134 of the composite optical system 130.

With regard to the replacement of the light source 115, if the light source module 110 has the structure in which the case 201 can be fully separated therefrom, the two light source sections 111 and 112 may be replaced at once while still being housed in the light source module 110, or either one of the light source section 111 or the light source section 112 having a light source 115 that is to be replaced may be removed from the unit case 113 for replacement. On the other hand, if the light source module 110 has the structure in which the case 201 cannot be fully separated therefrom, either one of the light source section 111 or the light source section 112 having a light source 115 that is to be replaced will be removed from the unit case 113 for replacement (cf. FIG. 6).

(2) When installing a new light source 115 in the case 201.

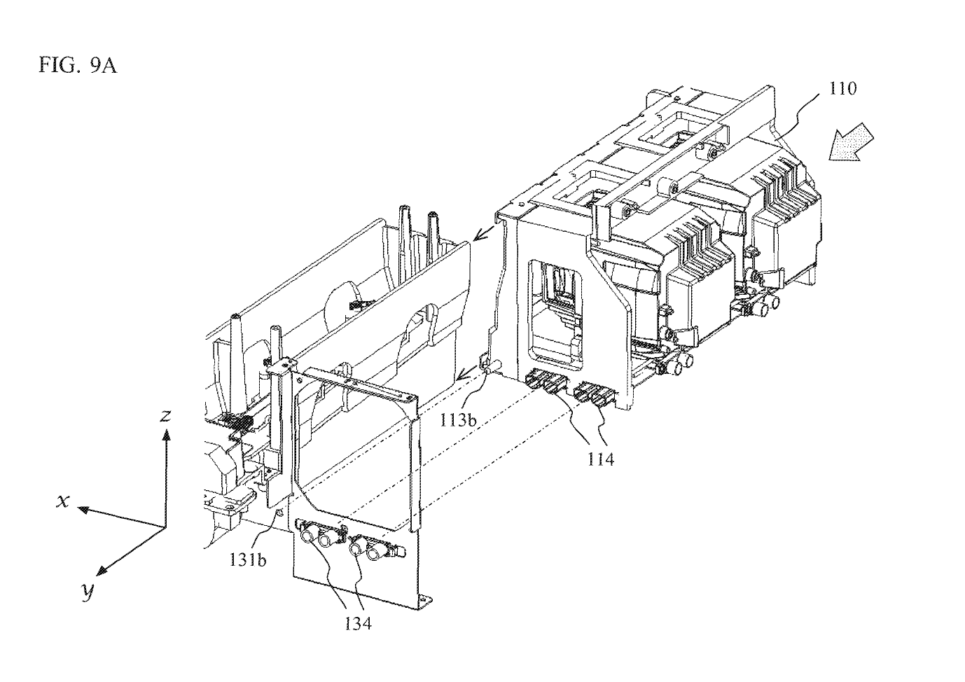

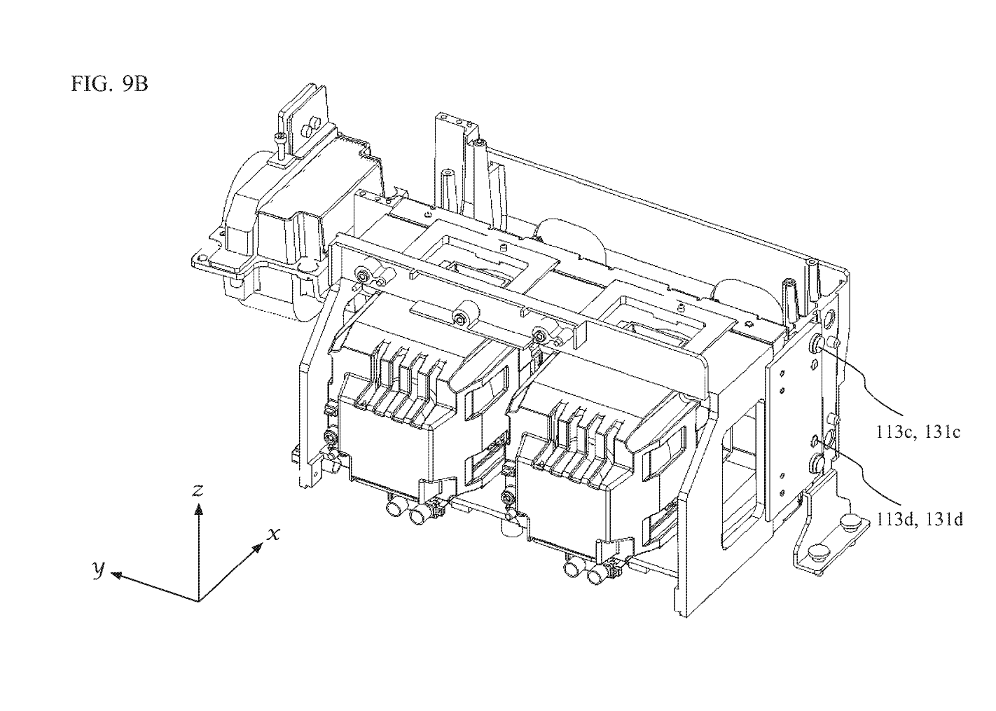

A completely new light source module 110 or an old light source module 110 but having a newly replaced light source section 111 or light source section 112 is prepared and inserted through the opening 205 of the case 201 having the opening cover 202 removed therefrom. At this moment, the guide groove parts 113a formed on the unit case 113 are aligned to the positions of the guide-rail parts 131a formed on the composite optical system 130 and are inserted therein (FIG. 9A), and the light source module 110 is inserted until it reaches the back end of the case 201 while having the guide groove parts 113a and the guide-rail parts 131a slidingly fit to each other. At this moment, since the first protrusion 113b formed on the unit case 113 of the light source module 110 is formed so as to extend further outward than the junction cable connection terminals 114, at first, the first protrusion 113b is inserted in the first hole part 131b formed on the composite base 131 of the composite optical system 130.

With this, the positions of the junction cable connection terminals 114 of the light source module 110 are guided to the positions of the power-supply connection terminals 134 of the composite optical system 130, and the junction cable connection terminals 114 fit into the power-supply connection terminals 134 securely. In addition, the second protrusion 113c formed on the unit case 113 of the light source module 110 is inserted in the second hole part 131c formed on the composite base 131 of the composite optical system 130; and the protrusion 131d formed on the composite base 131 of the composite optical system 130 is inserted in the hole part 113d formed on the unit case 113 of the light source module 110 (FIG. 9B).

As described above, with the projection type image display apparatus 100 according to one embodiment, even when the apparatus includes multiple light sources, a user can easily remove, from the apparatus, and replace one portion or all of the multiple light sources.

It should be noted that in the above described embodiment, an example in which the number of light source modules is two has been described. However, the number of light source module included in the projection type image display apparatus 100 may be one, three, or more. In addition, the number of light source sections installed in a single light source module may be three or more. Furthermore, it is not necessary to have all light source sections included in the projection type image display apparatus 100 to be a part of a light source module, and one portion of the light source sections may exist as a stand-alone component.

In addition, the quantities, positions, and shapes etc., of the protrusions and hole parts formed on the unit case 113 of the light source module 110 and the composite base 131 of the composite optical system 130 are not limited to those in the one example described in the present embodiment; and the protrusions and hole parts may be formed in different quantities, positions, and shapes.

In addition, in the above described embodiment, an example has been shown in which the guide groove parts 113a and the guide-rail parts 131a are respectively formed on the unit case 113 of the light source module 110 and the composite base 131 of the composite optical system 130. However, the advantageous effect of the present disclosure can be obtained also when the guide-rail parts and the guide groove parts are respectively formed on the unit case 113 and the composite base 131. Furthermore, the shapes of the guide groove parts 113a and the guide-rail parts 131a can be designed freely as long as they can slidingly fit to each other.

As presented above, one embodiment has been described as an example of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiment has been described to exemplify the technology according to the present disclosure, and therefore, various modifications, replacements, additions, and omissions may be made within the scope of the claims and the scope of the equivalents thereof.

What is claimed is:

1. A projection type image display apparatus including, in a case thereof, multiple light source sections for outputting light, the apparatus comprising:
a light source module including, as a unit, at least two light source sections among the multiple light source sections;
a composite optical system configured to combine light outputted from each of the at least two light source sections included in the light source module;
an illumination optical system configured to parallelly output the light combined by the composite optical system; and
a projection optical system configured to modulate and project, onto a screen, the parallel light outputted by the illumination optical system, wherein
the case includes guide parts configured to move in and out the light source module through an opening disposed on a lateral surface of the case.

2. The projection type image display apparatus according to claim 1, wherein
the at least two light source sections are detachably housed in a unit case of the light source module, and is supplied with power through a junction cable.

3. The projection type image display apparatus according to claim 2, wherein
the light source module includes, on the unit case thereof, a connection terminal electrically connected with the junction cable, and
when the light source module is installed in the case, the connection terminal of the junction cable is connected with a power-supply connection terminal disposed on the case for supplying power.

4. The projection type image display apparatus according to claim 1, wherein
the opening of the case has an opening cover having a function of controlling a power supply state such that the projection type image display apparatus becomes inoperable when it is removed from the case.

5. The projection type image display apparatus according to claim 2, wherein
the at least two light source sections are housed in the unit case such that all their optical axes are parallel and intersect a straight line, and
the light source module is operable to be moved in and out via a lateral surface of the case in a direction of said straight line.

6. The projection type image display apparatus according to claim 1, wherein
the light source module is operable to be fully separated and removed from the case.

7. The projection type image display apparatus according to claim 3, wherein
the light source module includes a protrusion extending further outward than the connection terminal of the junction cable, and
during installation of the light source module in the case, the protrusion is inserted in advance in a hole part disposed on the case for assisting fitting of the connection terminal of the junction cable into the power-supply connection terminal.

8. The projection type image display apparatus according to claim 1, wherein
the guide parts are a mechanism configured to slidingly fit the light source module and the composite optical system, and
the guide parts are formed at edges located at top and bottom of a lateral surface of the composite optical system facing the light source module, and at edges that are located at top and bottom of a lateral surface of the light source module facing the composite optical system and between which the optical axes of the at least two light source sections are located.
